(19) United States
(12) Patent Application Publication
(10) Pub. No.: US 2009/0192816 A1
(43) Pub. Date: Jul. 30, 2009

(54) System and method for assisting contributors

(75) Inventors: Mark DeBiase, Colorado Springs, CO (US); Gregory Ring, Colorado Springs, CO (US); Dave Keesling, Woodland Park, CO (US); Don H. Johnson, Huntsville, TX (US)

Correspondence Address: SHERIDAN ROSS PC, 1560 BROADWAY, SUITE 1200, DENVER, CO, 80202, US

(73) Assignee: PhilanthroCorp, Colorado Springs, CO (US)

(21) Appl. No.: 12/316,954

(22) Filed: Dec. 16, 2008

Related U.S. Application Data
(63) Continuation-in-part of application No. 11/522,159, filed on Sep. 18, 2006, now abandoned.

(51) Int. Cl. G06Q 99/00

(52) U.S. Cl. 705/1

(57) ABSTRACT

A management system for managing, streamlining and automating the process of obtaining contributions for philanthropic entities (e.g., charities and other non-profit organizations), wherein user friendly Internet based processes are provided to (potential and actual) contributors that substantially eases the burden on such contributors in, e.g., contributing to such entities via planned giving or estate planning. For each of the philanthropic entities, the management system automates and facilitates the marketing and estate planning aspects for obtaining contributions in a manner that is consistent with the avowed beliefs and/or values of the entity, and that provides potential and actual contributors with contacts to professionals that also share the beliefs and/or values of the entity.

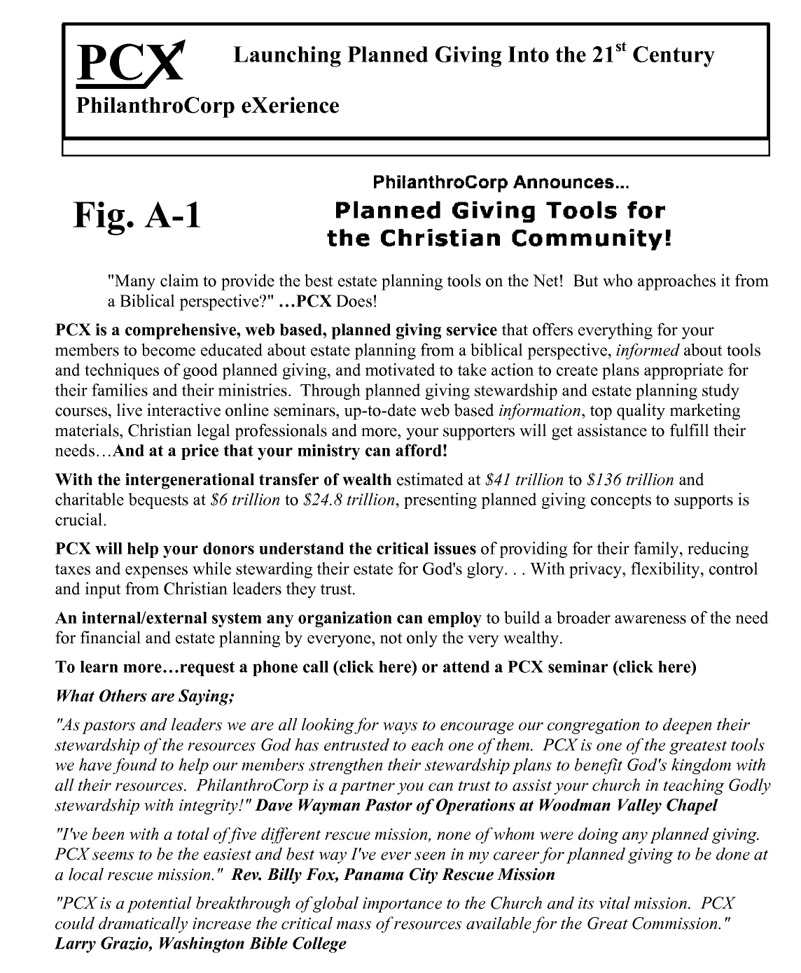

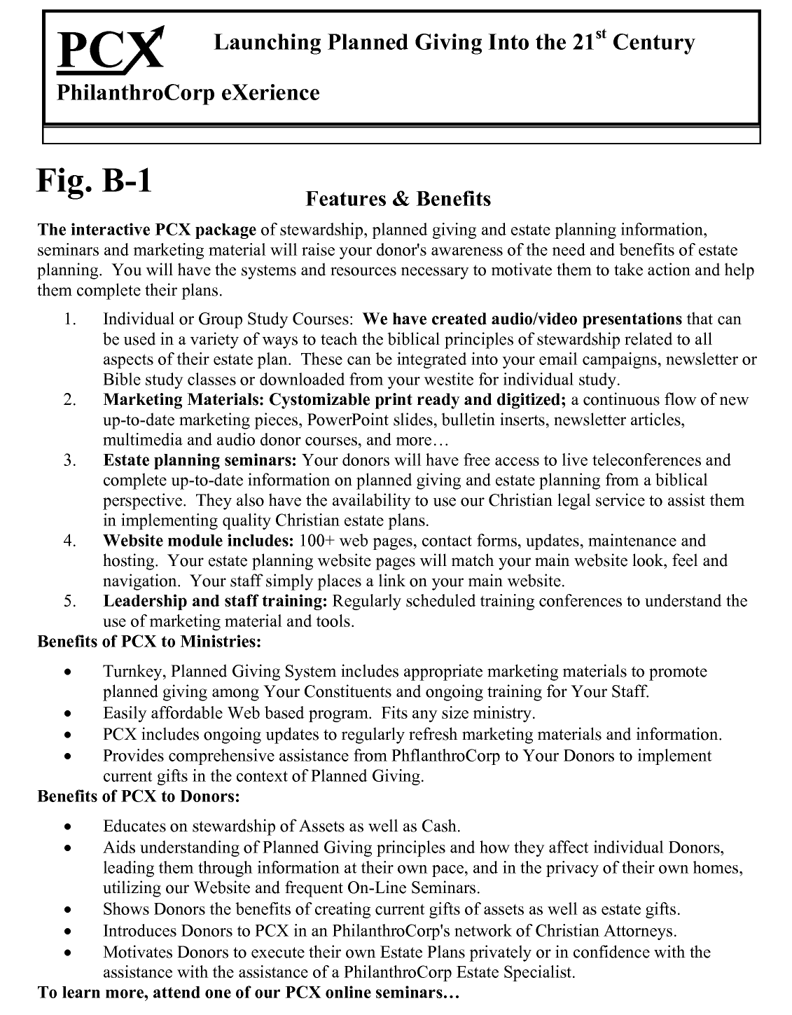

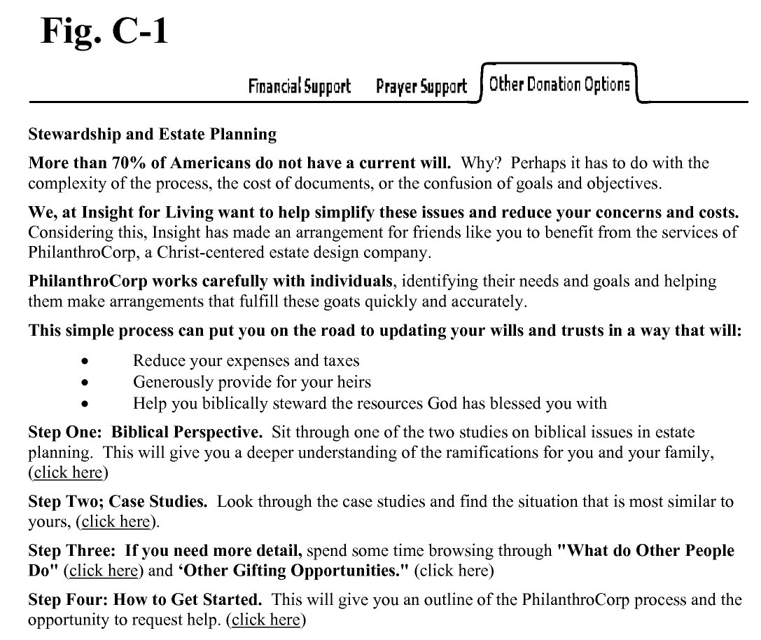

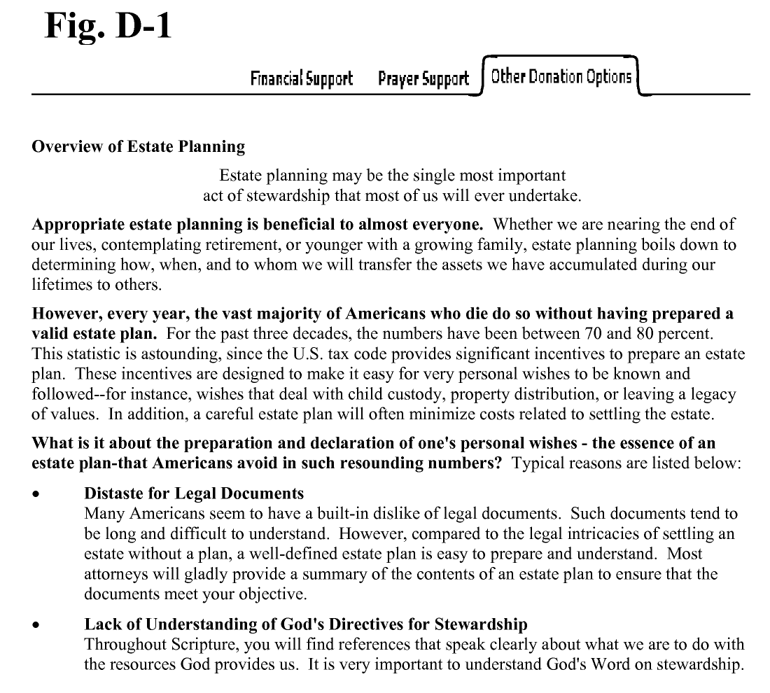

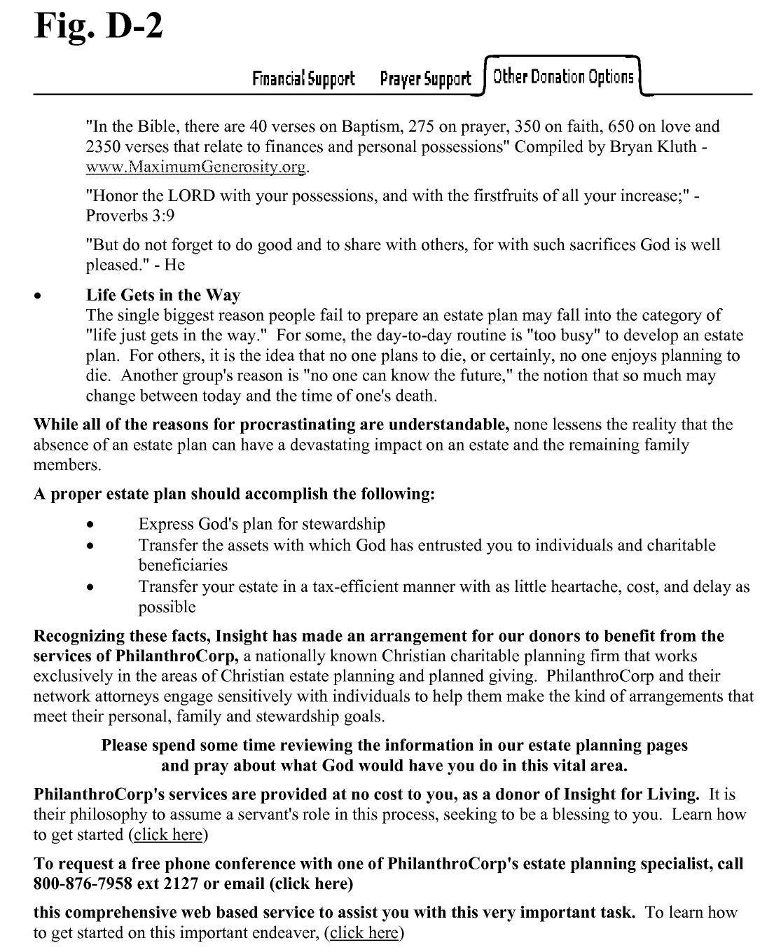

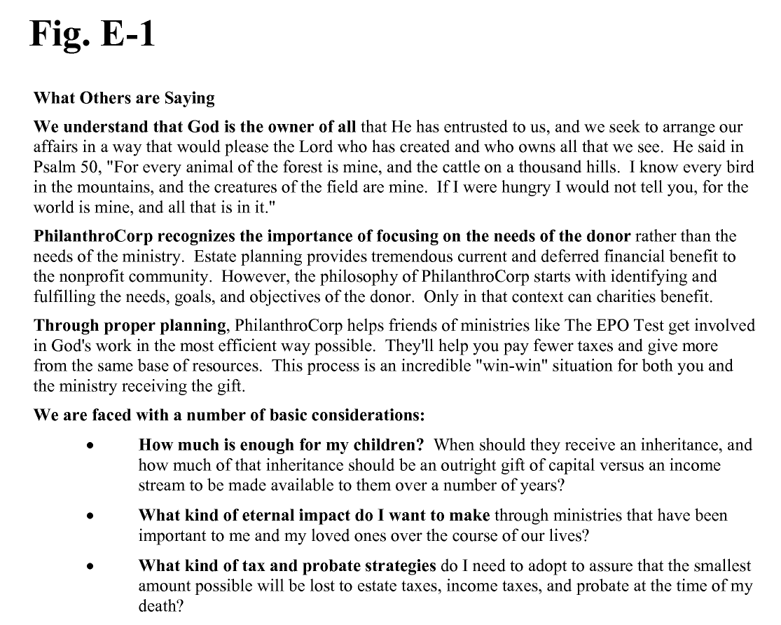

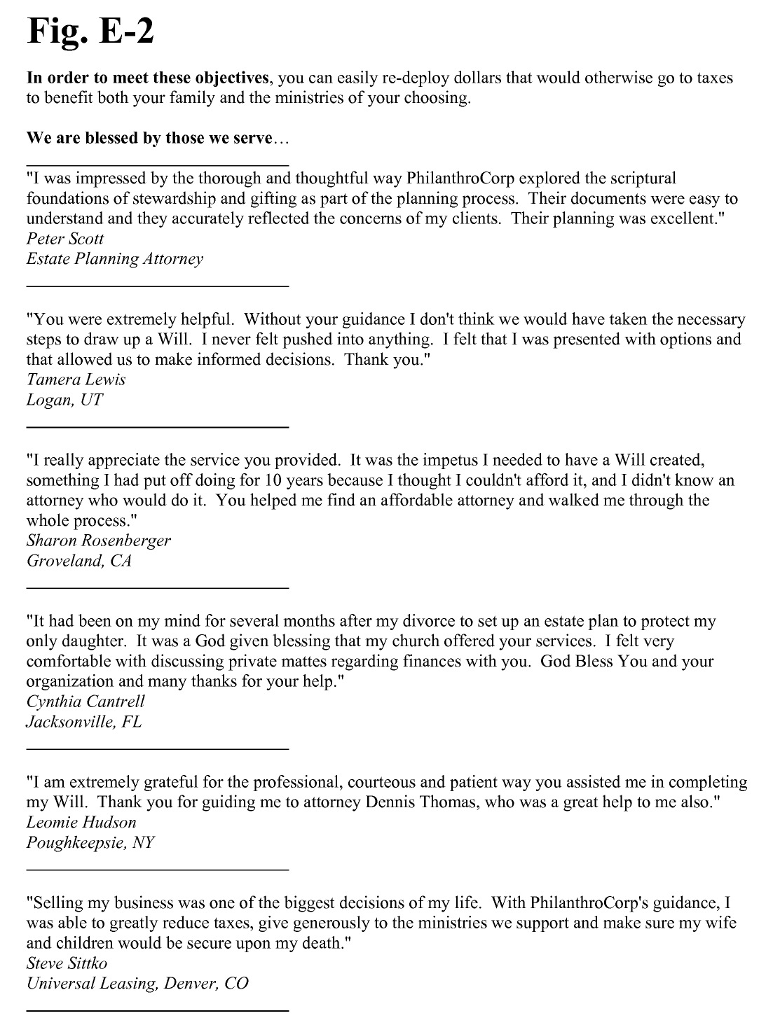

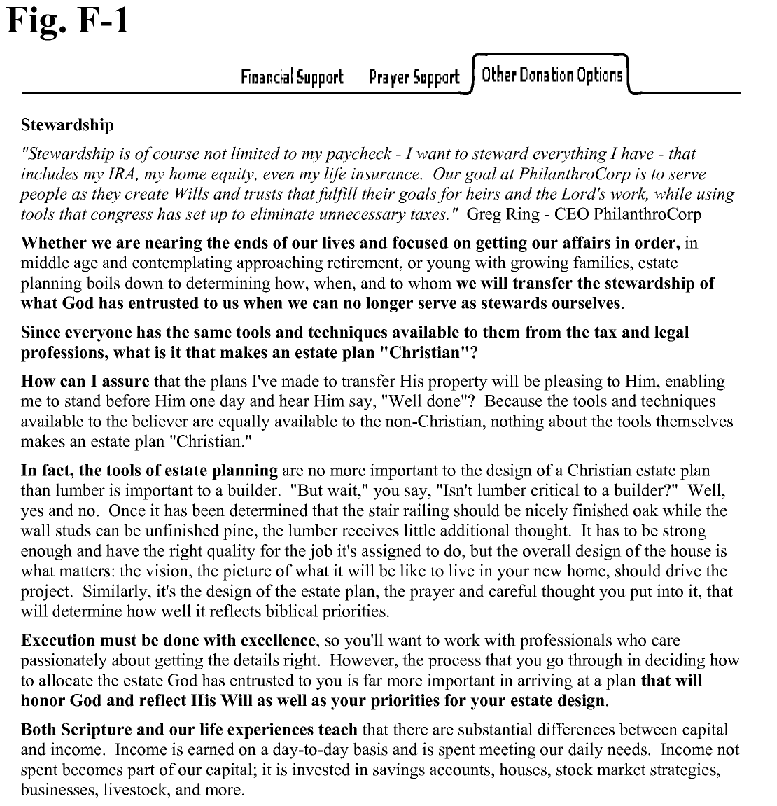

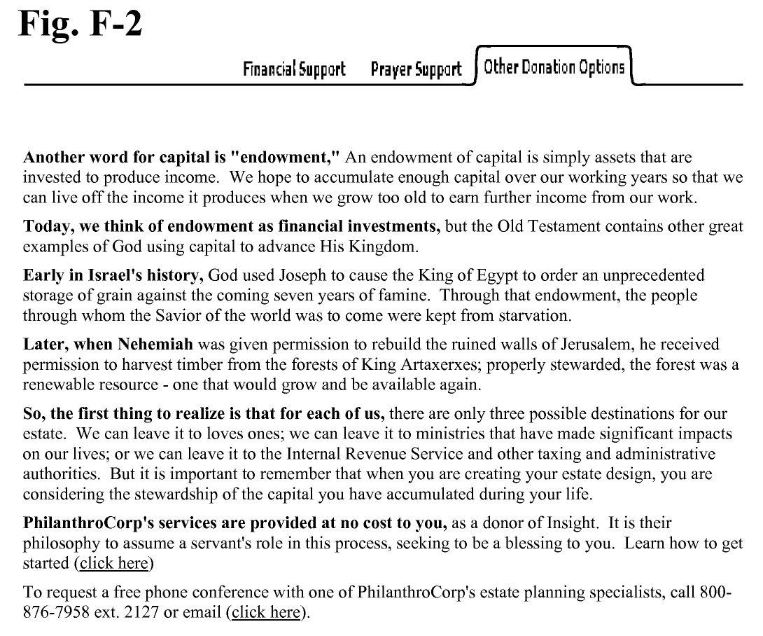

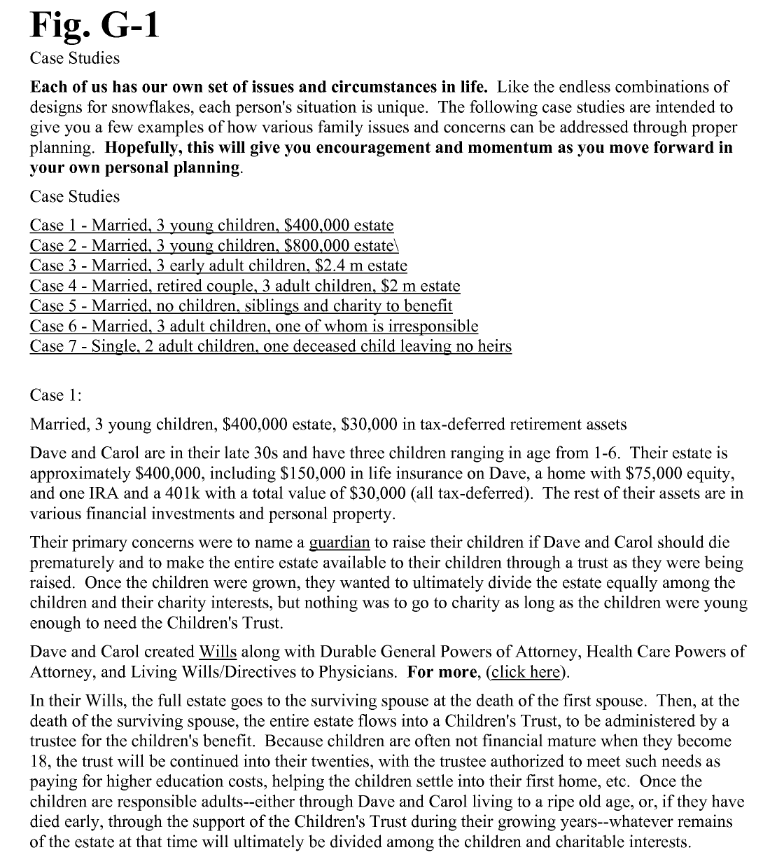

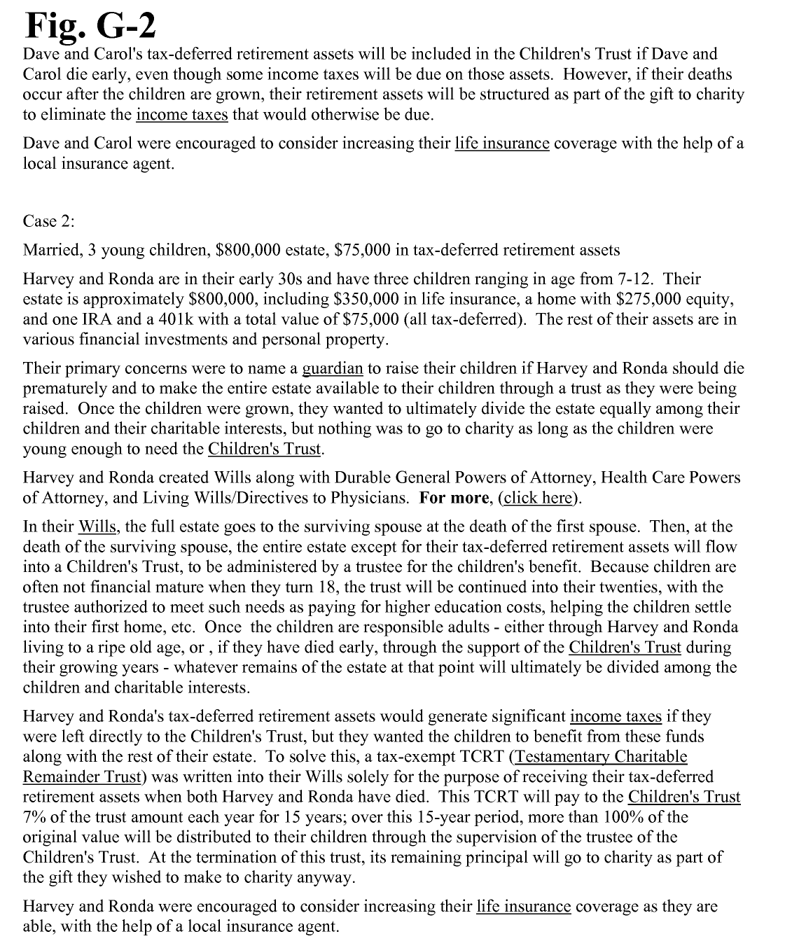

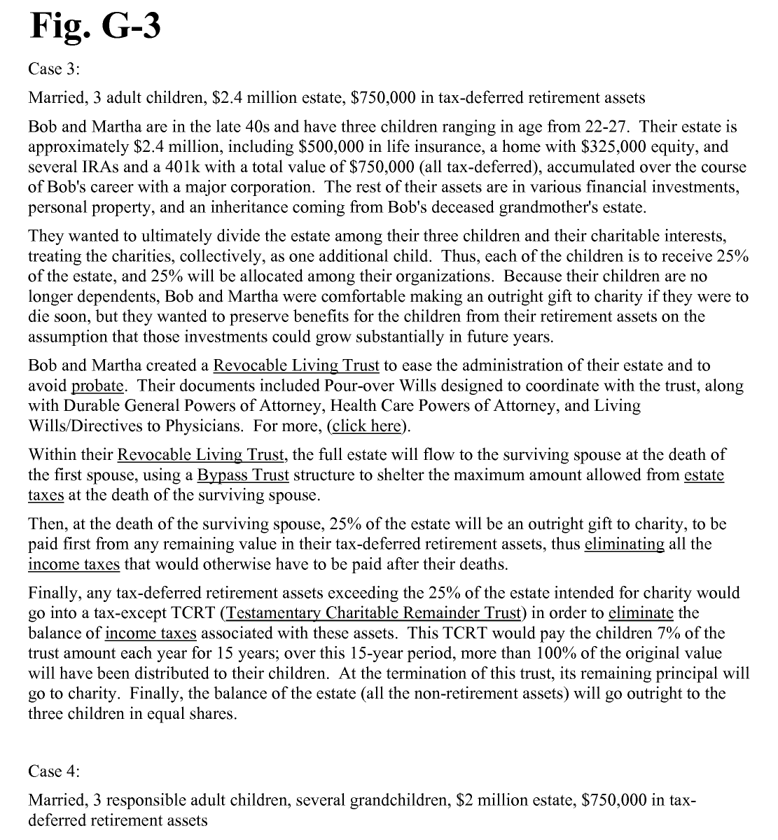

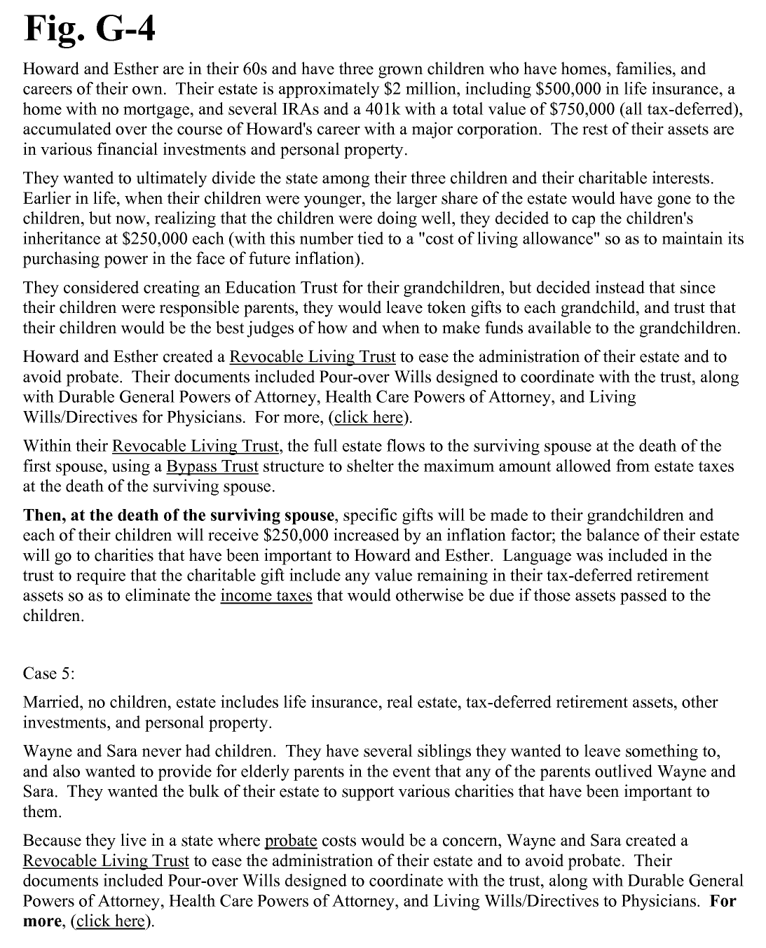

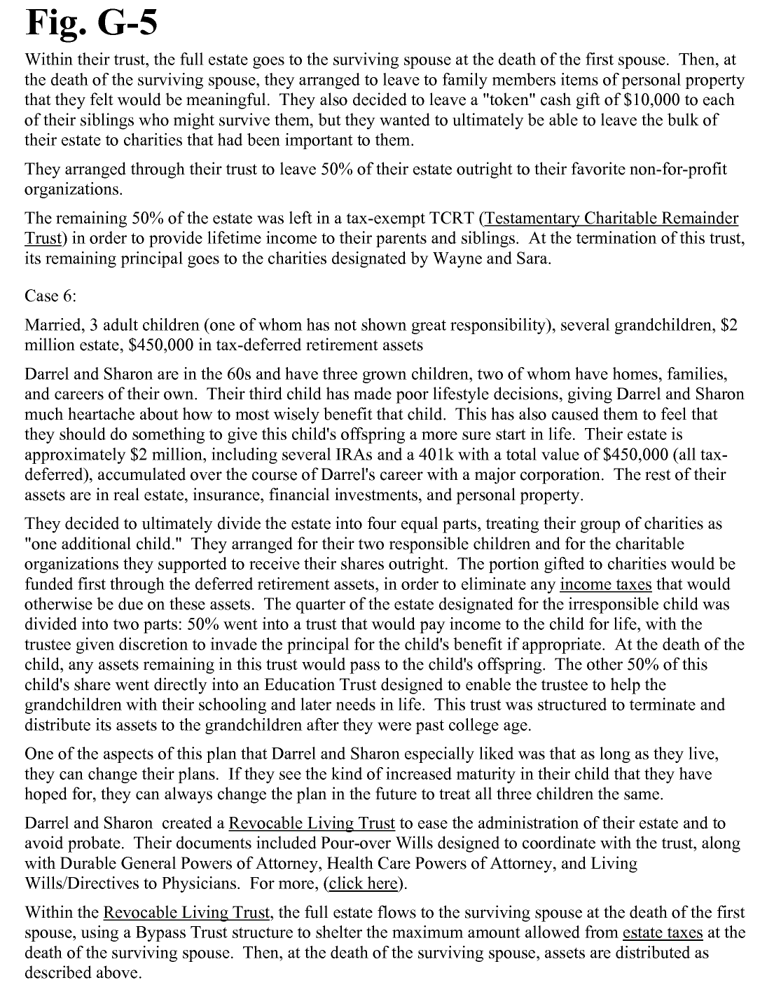

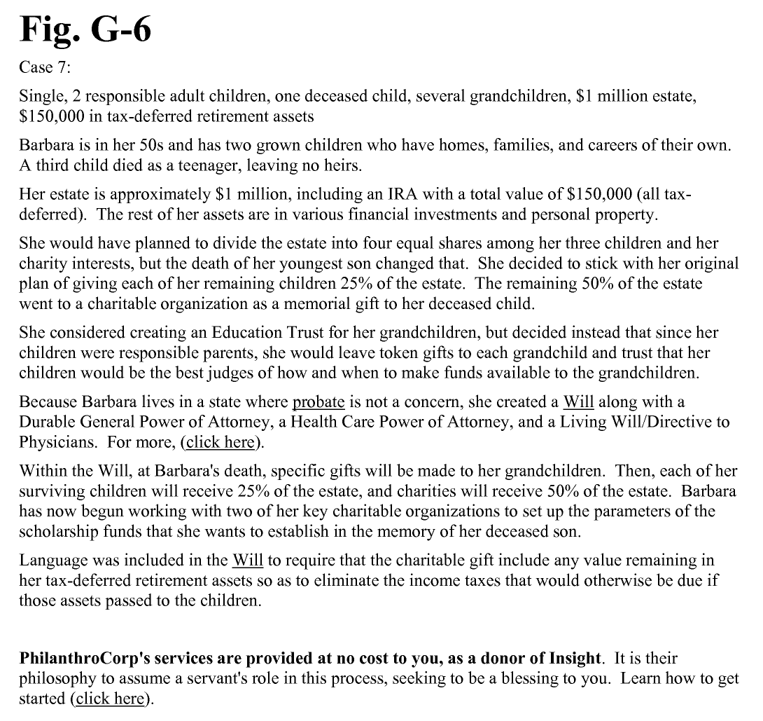

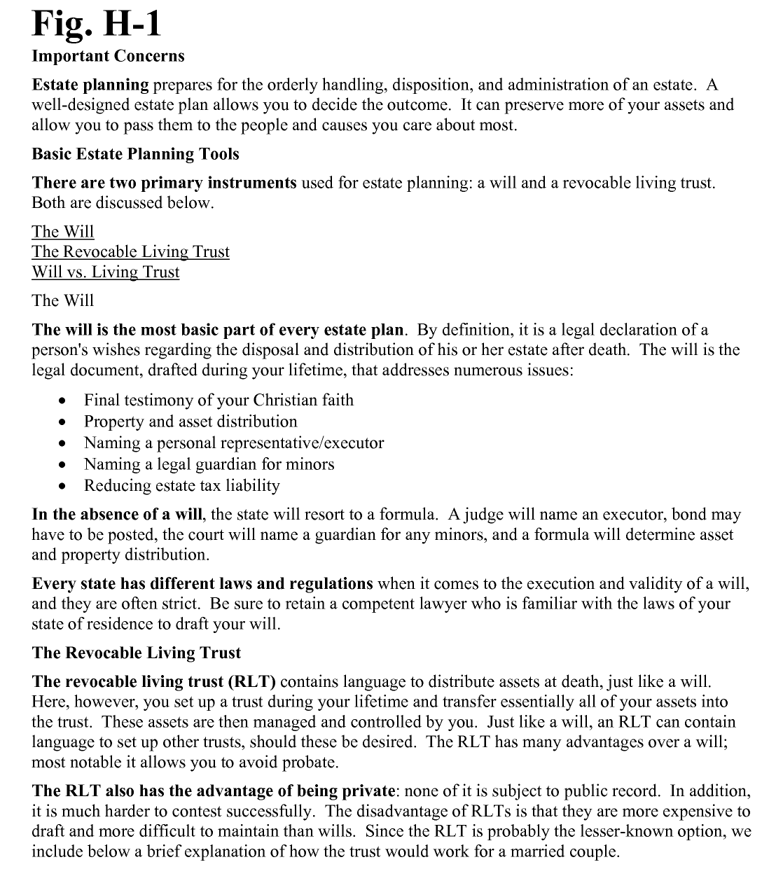

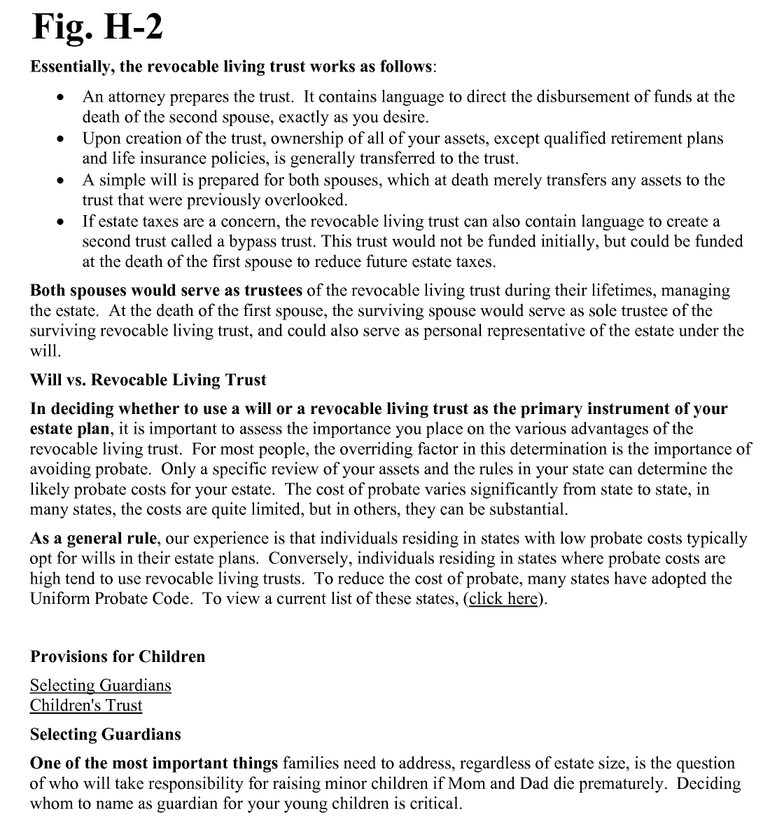

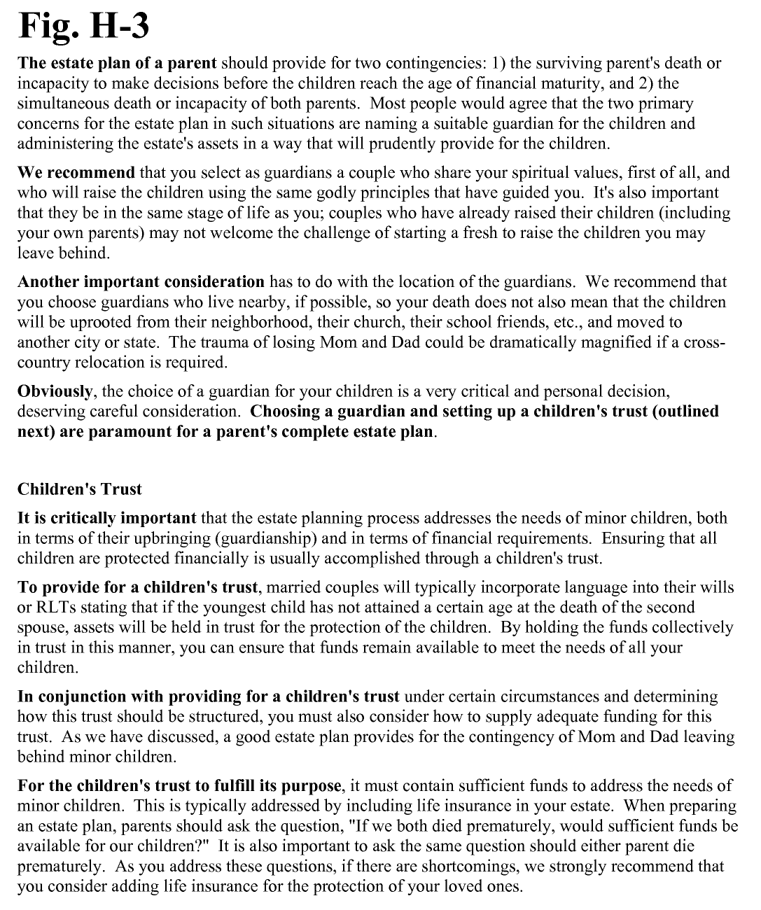

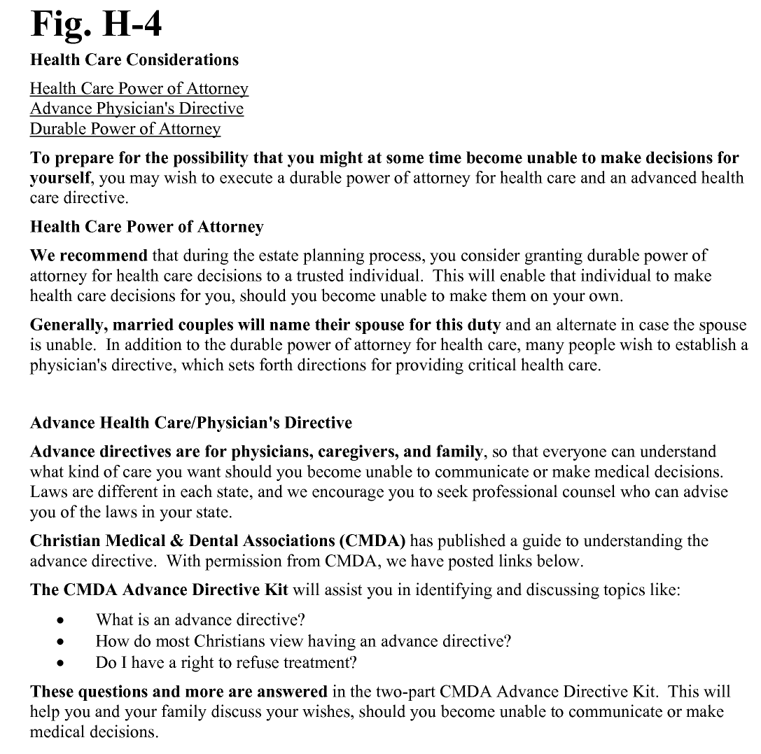

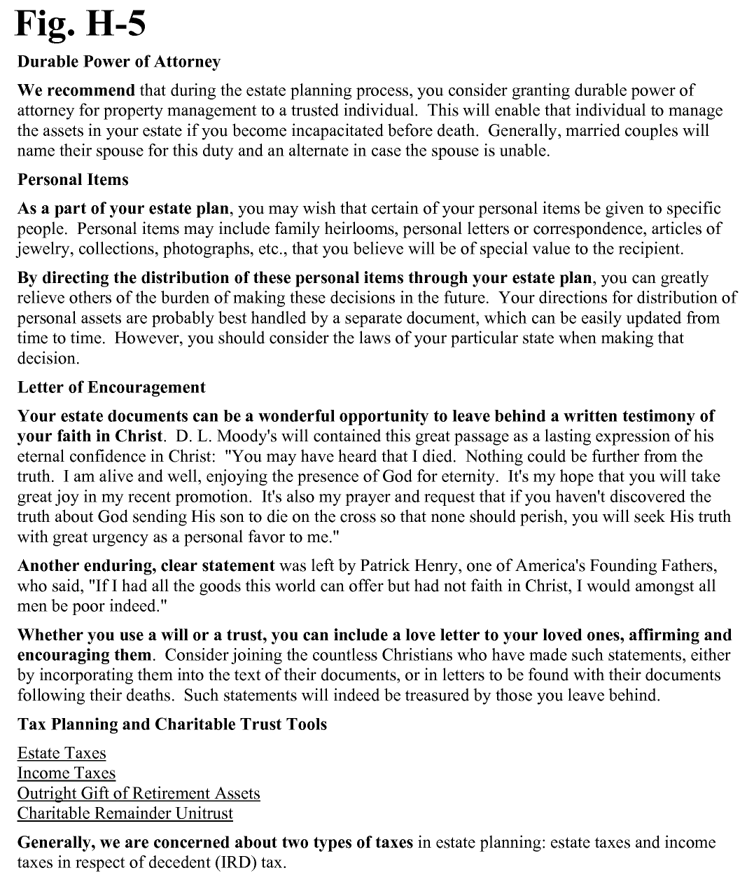

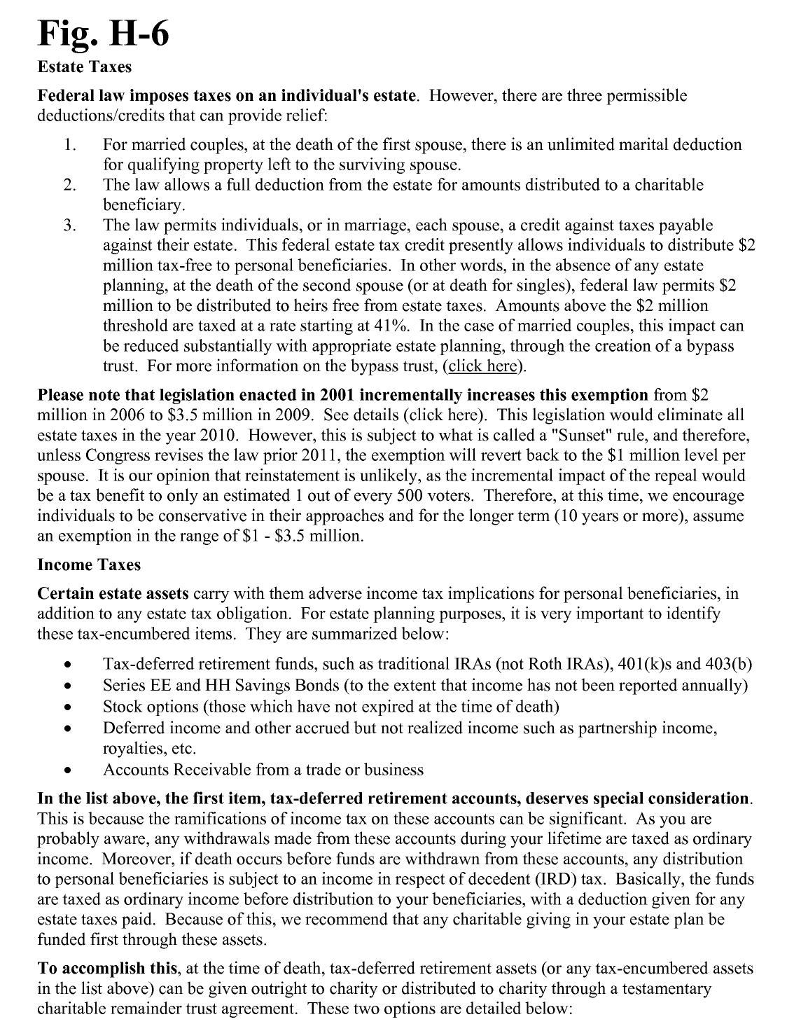

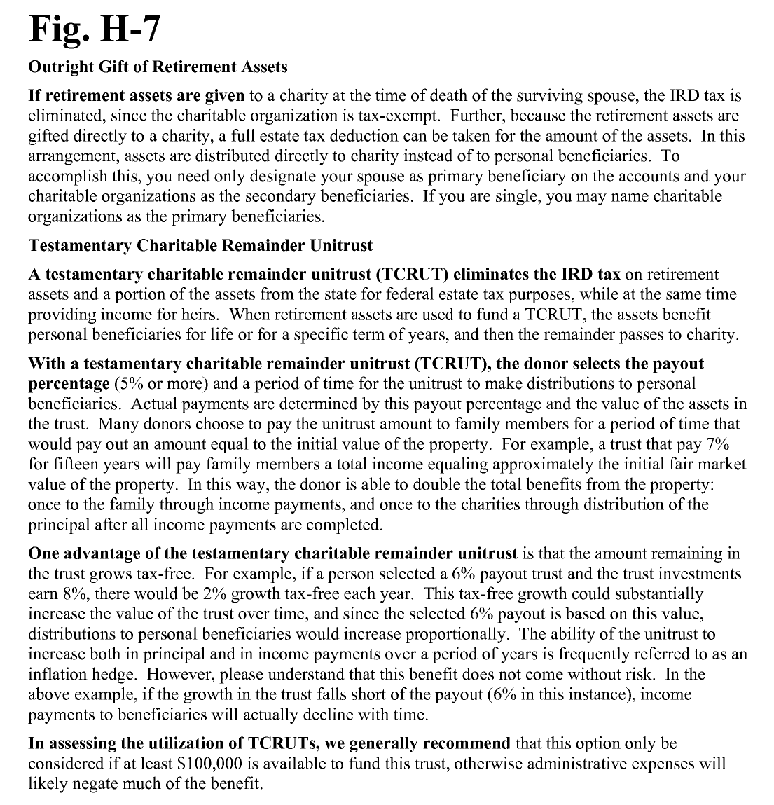

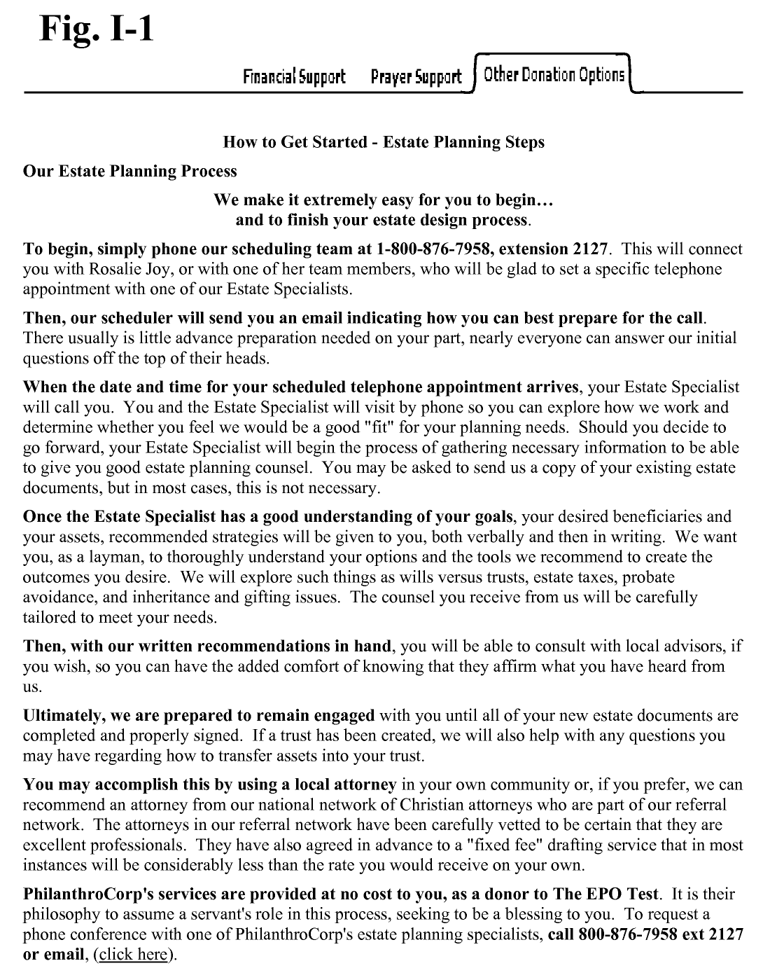

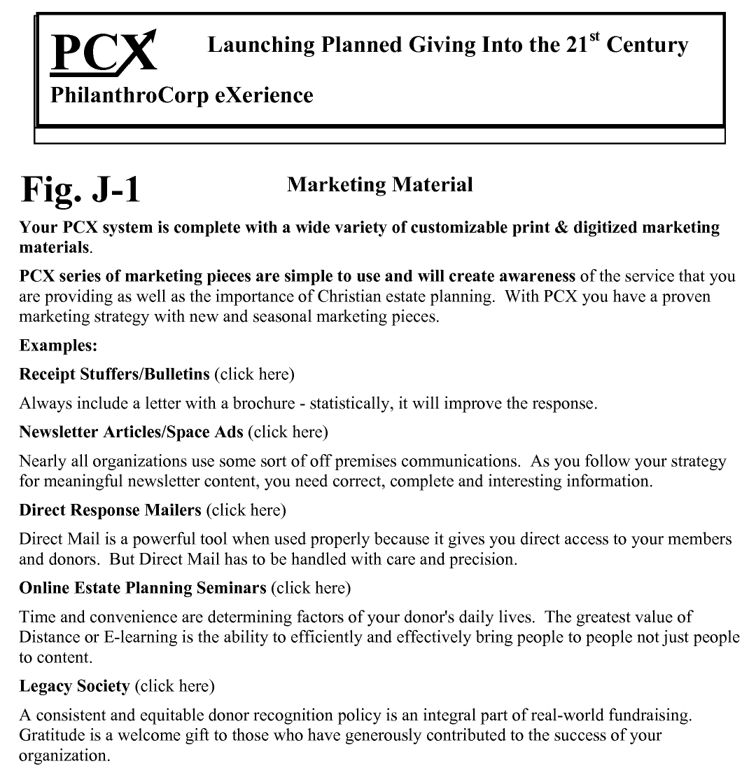

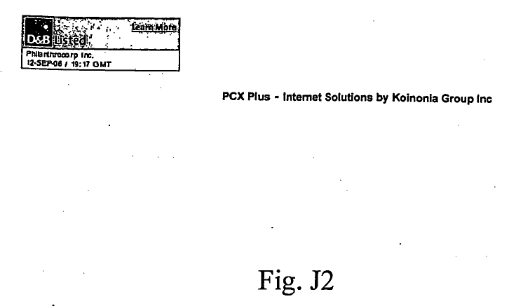

### CROSS REFERENCE TO RELATED APPLICATION

The present application is a continuation-in-part of U.S. patent application Ser. No. 11/522,159 filed Sep. 18, 2006, the entire contents of this previous application is fully incorporated herein by reference.

### RELATED FIELD OF THE INVENTION

The present disclosure describes a method and system for a user friendly, Internet based estate planning and planned giving tool available for a wide area network (Internet) for, e.g., non-profit organizations and their donors (more generally contributors herein), wherein the method and system may be driven at least partially by data indicative of a predetermined perspective consistent with the organization's values and operating procedures.

### BACKGROUND

There is a need for method and system for managing the effort of soliciting and obtaining contributions for philanthropic organizations or entities, and additionally for easing the effort required by contributors. The present disclosure describes such a method and system.

### SUMMARY OF THE INVENTION

The present disclosure is generally directed to a user friendly web based system and method which provides entities (particularly, non profit entities) and their contributors (candidate or actual) therefor with presentations, materials, strategies, and other resources for allowing such entities and candidate contributors:
(a) To better understand and appreciate philanthropic endeavors, processes and techniques regarding philanthropic contributions (e.g., donations) and the reasons therefor;
(b) To provide educational materials and presentations regarding planned/scheduled contributions, tax matters related to contributions, wherein such materials can be generally applicable a wide range of circumstance, as well as customized to a particular entity and/or contributor's circumstances;
(c) To provide software tools for assisting in, e.g., determining financial projections for contributors which may include modeling a contributor's financial circumstances through time, and/or providing representations of tangible physical objects that such an entity or a contributor may or may not be able to purchase or obtain given the contribution(s) made or not made;
(d) To provide a web based estate plan organizer wherein contributors can confidentially input personal, financial information and receive advice regarding various estate planning ideas and/or scenarios;
(e) To provide contacts with professionals familiar with philanthropic matters; and in particular, provide access to and/or referrals from one or more social/professional networks of individuals and organizations to assist the (potential) contributors in their estate planning matters, wherein reduced fees may be charged to such contributors. In one embodiment, a network of attorneys may be provided that share, affirm or otherwise are well versed in issues related philanthropic giving; and
(f) To provide any or all of the above information and materials in a manner that is consistent with a predetermined perspective of the (potential) contributor's values and/or with a predetermined perspective of the values and operating procedures of an organization or entity utilizing the method and system disclosed herein solicit donations or contributions from (potential) contributors.

In one embodiment of the method and system of the present disclosure automated e-mail messages are provided to potential or actual donors (e.g., who have requested information) for a plurality of organizations or entities contracting or otherwise providing access to the philanthropic services disclosed herein. For each such organization or entity, the e-mail messages generated therefor may include graphics, logos and other information for identifying the organization or entity as well as hyperlinks to Internet services and information provided by an embodiment of the presently disclosed method and system. In particular, such e-mail messages provide potential or actual donors (collectively also identified as “contributors” herein) with information promoting seminars related to philanthropic giving, current tax advantages for giving opportunities and charitable estate planning. Moreover, such emails may be substantially automatically generated for combining, e.g., information provided by the organization or entity (e.g., specifically for a particular collection of emails to be transmitted on a specific date), information identifying the organization or entity (logos, etc.), philanthropic information and presentations customized to the organization or entity, and access to software tools for modeling and/or determining financial or life style projections related to philanthropic giving.

In one embodiment of the method and system of the present disclosure network seminars (e.g., webinars) are provided to inform participants about various estate planning and charitable giving matters. Participants of instances of such seminars may be provided with authorization information providing access to such seminars. Such seminars may provide information to assist contributors in their estate planning needs. Such seminars may be presented on one or more communication networks, e.g., the Internet, a phone network, a wireless network, or a combination of networks wherein presentation media from various networks are combined or synchronized to provide enhanced user (contributor) experiences. Accordingly, such seminars (more generally, “presentations”) may be tailored to the presentation capabilities of each presentation participant. Thus, participants may be provided with a version of a presentation that utilizes only audio communication, while other participants may be provided with a version of the presentation that utilizes audio plus a low (or erratic) visual presentation, e.g., via a low data rate Internet connection, while other participants may be provided with a version of the presentation that utilizes a high speed broadband Internet connection that in near real time supports two way network communication with such participants.

In one embodiment of the method and system of the present disclosure reports to contributors are automatically and/or periodically generated for distribution to the contributors of organizations or entities. Such reports may be of a financial nature and may be confidential to the contributor. Accordingly, a contributor may be utilizing the presently disclosed method and system for receiving such confidential information from a plurality of different or independent organizations or entities, such confidential information is disclosed selectively as specified by the contributor. Thus, the contributor may request all information relating to philanthropic contributions managed or accessed via the presently disclosed system and method (herein also identified as a “philanthropic management system”) be provided to him/herself, all information relating to a first collection of one or more philanthropic organizations or entities be provided to one or more specified individuals, and not providing any information related to the contributor's dealings with another second collection of one or more philanthropic organizations or entities. Moreover, the contributor's philanthropic related information across a plurality of charitable organizations or entities may be combined into a unified report for the contributor.

Additionally, a contributor may provide contribution rules or constraints to an embodiment of the present method so that changes in contribution amounts to various organizations or entities can be automatically implemented dependent upon, e.g., one or more of: (i) a total amount (or projected amount to be) in a trust fund, (ii) an amount of profit (or projected amount to be) made by such a trust, (iii) a yearly income received by a particular business, philanthropic organization or entity, or a particular individual, (iv) an age of a particular individual, (v) total maximum amount to be allocated for contributions, (vi) a priority or ranking of types of assets from which contributions are to be made. Thus, a contributor may specify rules such as the following rules:
(a) If charitable organization A's total net assets is greater than $1,000,000 then retain 5% of the contributor's annual contribution to A;
   Else if the charitable organization A's total annual income for each of two consecutive years is less than $500,000, then add an additional 5% to the contributor's annual payment from retained amounts, and cease all payments if in the third year organization A's total annual income is less than $500,000.
(b) If a charitable organization B increases the number of orphans being housed increases 5% in any one year, then increase the contribution to B by 3%.
(c) Cease (decrease or suspend) or commence (increase or re-commence) contributions to charitable organization C when a predetermined condition occurs, e.g., a particular individual reaches a certain age, contributor's total asset base falls below (rises above) a predetermined amount, the annual income of a particular person falls below (rises above) an inflation adjusted amount, the collective instructions from a predetermined group of individuals or entities, etc.

Accordingly, in one embodiment, the presently disclosed philanthropic management system may not only monitor a contributor's charitable or philanthropic giving, but also assist in the actual allocation of contributions according to, potentially complex, rules or instructions provided by the contributor. Additionally/alternatively, it is within the scope of the present disclosure that contributors may have access to financial tools for modeling their contributions into the future according to such rules, wherein, e.g., various scenarios may be generated by the philanthropic management system disclosed herein. In particular, such scenarios may be substantially more complex than merely assuming certain annual return rates of various asset types. For example, such scenarios may take into account historical information about what is likely to be the result on a given one or more charities (or types thereof) of an economic downturn in, e.g., the global (or a national) economy. Thus, the contributor may enter rules that try to balance competing needs for the contributor's contributions, wherein a balance may depend on both the likely economic health of one or more charitable organizations as well as the contributor's assets. Moreover, statistical (Markov) simulations may be performed providing contributors with information about likely outcomes such as when a trust fund would be likely to be depleted, under what circumstance would contributions to health related charities exceed contributions to drug addiction prevention related charities assuming economic fluctuations in the future can be approximated by economic fluctuations in the past.

In one embodiment of the philanthropic management system of the present disclosure provides training and/or configuration assistance for non-profit clients (e.g., charitable organizations and entities) and their staff via network (Internet) communications. In particular, such training or assistance may assist such staff in profiling various types of contributors according to various characteristics, e.g., a geographical area(s) contributors reside, or contributor charitable giving history, or demographic group(s) such as: age group(s), income level group(s), educational level group(s), organization affiliation(s). Such profiling can be used to identify additional prospective contributors to a charitable organization or entity.

In one embodiment of the philanthropic management system of the present disclosure charitable organizations or entities may also be profiled for assisting contributors in diversifying their contributions over a plurality of such organizations or entities. For example, a contributor (advisor thereto) that has accessed the presently disclosed philanthropic management system for investigating contributing to a particular charity or non-profit organization may be provided with access to one or more of the following:
(a) Access to the identification of other philanthropic organizations or entities that other contributors to the particular charity or non-profit also contribute;
(b) Contribution diversification or allocation information aggregately collected from other contributors having similar contributor profiles and/or interests;
(c) Ratings of the performance of philanthropic organizations or entities, wherein such ratings are provided by the contributors thereto;
(d) Access to an “intelligent” search engine(s) allowing a contributor to search for prospective philanthropic organizations or entities that may be of interest to the contributor, wherein, e.g., the contributor need not necessarily enter explicitly for such a search the information used by the engine(s), and the results may include information describing why each resulting philanthropic organization or entity is presented to the contributor.

In one embodiment of the philanthropic management system of the present disclosure, downloadable, customizable marketing materials may be provided to non-profit entity clients. Such materials may cover various topics pertinent to charitable giving, tax planning and estate planning.

In one embodiment of the philanthropic management system of the present disclosure, this management system may be branded for private-label of various client philanthropic organizations or entities. Such branding may be integrated into each such client's corresponding website.

In one embodiment of the philanthropic management system of the present disclosure professional advisors for facilitating/enabling planned contributions may also be profiled for assisting contributors in providing contributions. For example, a contributor may access the presently disclosed philanthropic management system for investigating such advisor(s) may be provided with access to one or more of the following:
(a) Access to the identification of such advisors that other contributors have used;
(b) Information on advisor preferences aggregately collected from other contributors having similar contributor profiles and/or interests;
(c) Ratings of the performance of such advisors, wherein such ratings are provided by the contributors that used such advisors; and
(d) Access to an “intelligent” search engine(s) allowing a contributor to search for prospective advisors that may be of interest to the contributor, wherein, e.g., the contributor need not necessarily enter explicitly for such a search the information used by the engine(s), and the results may include information describing why each resulting advisor identified is presented to the contributor.

In one embodiment of the philanthropic management system of the present disclosure, an on-line, interactive, estate planning interactive guide (also referred to as an “estate planning agent”) which contributors can utilize to assist in (preparing for) drafting estate planning documents. This web based interactive planning guide can take contributors (or other users) step by step through an estate planning process, wherein a result therefrom may be: (i) initial drafts of certain documents and/or the information necessary for having such final documents drafted by a professional such as an estate planner or attorney. Such documents may include wills, revocable living trusts, bypass trusts, testamentary charitable remainder trusts, and children's truss, etc. Note that the philanthropic management system may be used for securely submitting such initial document preparation information to one or more advisors, e.g., for allowing the contributor to obtain an initial consultation with the advisors, and for obtaining fee estimates. Such submissions may be conveyed electronically via the Internet.

In one embodiment of the philanthropic management system of the present disclosure a preferred collection of attorneys and/or other professionals may be accessed by the management system for selecting prospective professionals to be identified to a contributor. The selected prospective professionals may be selected according to their geographic proximity to the contributor (e.g., in a same city or metropolitan region as the contributor resides), fee structure for preparing estate planning and charitable contribution documents, special expertise of the professional, etc.

In one embodiment of the philanthropic management system of the present disclosure “belief” based in that the beliefs of the contributors and advisors are taken into account in identifying, selecting and determining how best to assist contributors in estate planning and charitable giving. In particular, for a client philanthropic organization utilizing a belief based philanthropic management system, such a management system may be characterized by:
(a) Determining, storing and providing documents and other information to contributors for the client philanthropic organization, wherein the documents and other information are at least consistent with (and preferably bolsters) the client philanthropic organization's beliefs and/or values relating to situations, circumstances and/or events that occur beyond the lifetime of the contributor (in particular, as such information relates to philanthropic giving). The stored documents and other information is accessible for transmittal to contributors on a communications network (e.g., the Internet);
(b) Providing interactive network (Internet) communications between the client philanthropic organization or entity and one or more contributors for determining a financial or economic impact on each such contributor, wherein a quantitative financial or economic projection is provided to the contributor prior to the contributor consenting to a particular contribution, the projection showing a net negative financial or economic impact to the contributor and optionally his/her successors, and wherein the projection is based on financial or economic data;
(c) Selecting and/or providing to the contributors contacts for professionals and/or other individuals with expertise relating to, e.g., scheduled or planned contributions via estate planning and legal issues related thereto, wherein such selected individuals have beliefs and/or values about situations, circumstances and/or events that occur beyond the lifetime of such individuals that are at least consistent with (and preferably bolsters) the client philanthropic organization's beliefs and/or values relating to situations, circumstances and/or events that occur beyond the lifetimes of individuals identified with the philanthropic entity and beyond the lifetimes of the professionals;
(d) Filtering or deselecting professional contacts of individuals or entities having beliefs about situations, circumstances and/or events that occur beyond the lifetime of such individuals or entities that are at least inconsistent with the philanthropic organization's beliefs and/or values relating to situations, circumstances and/or events as described in (a) immediately above; and
(e) Restricting, filtering and/or precluding the providing of documents, information, and contacts for individuals that expressly state or otherwise have advocated acts that are inconsistent with the philanthropic organization's beliefs and/or values relating to situations, circumstances and/or events that occur beyond the lifetimes of individuals identified with and attesting to beliefs and/or values of the philanthropic entity.
   Such belief based features of the philanthropic management system are believed to be of particular interest to philanthropic organizations or entities, contributors, and advisors since it is believed that charitable giving is more belief driven than other financial exchanges.

In one embodiment of the philanthropic management system of the present disclosure, a preferred collection of attorneys and/or other professionals may be accessed by the management system for selecting prospective professionals to be identified to a contributor. The collection attorneys and/or other professionals may be selected for a particular client based on the values and beliefs of the contributor.

In one embodiment of the philanthropic management system of the present disclosure, legal services to clients' contributors may be provided with reduced legal rates. Such legal services are at no cost to the client.

In one embodiment of the philanthropic management system of the present disclosure, both the client philanthropic organizations and their contributors register with the management system for providing authenticated secure Internet communications.

In one embodiment of the philanthropic management system of the present disclosure, a turn-key charitable gift annuity system (including implementation and maintenance) is provided at no cost or reduced cost to a client philanthropic organization. For example, an operator of the philanthropic management system may receive compensation from the funding received from contributors to the client philanthropic organization, wherein such contributors utilized the management system. Alternatively/additionally, compensation to the operator of the philanthropic management system may receive a percentage of the annual income stream received from contributors to the client philanthropic organization, wherein such contributors utilized the management system.

The presently disclosed philanthropic management system is particularly beneficial for philanthropic entities or organizations that cannot afford the overhead of hiring one or more marketing and/or contributor care professionals. Since the management system disclosed herein provides common or similar services and materials to a potentially large number of philanthropic entities or organizations, much of the services and materials provided to clients can be based on generic services and materials that can be transformed into services and materials uniquely identified with each individual client. Such transformations are an important aspect of the functionality of the present management system.

Additionally, the presently disclosed philanthropic management system is particularly beneficial to philanthropic entities or organizations that have a very large number of contributors (e.g., 500,000) since it is financially infeasible for such an entity or organization to effectively communicate with such a large number contributors for soliciting contributions of a potentially complex nature such as planned giving via, e.g., estate planning. Accordingly, since the transforming of generic marketing materials related to planned giving and reasons therefor can be spread over a plurality of philanthropic entities or organizations, the present management system is particularly cost effective for philanthropic entities or organizations with large numbers of contributors, particularly since charges for use of present management system to a philanthropic entity or organization may be substantially (or entirely) independent of the number contributors to the entity or organization.

Any combination of the above-identified aspects of the philanthropic management system identified above can be provided in an embodiment of such a system. Other features and benefits of the present disclosure are described in the accompanying figures together with the description hereinbelow. In particular, various features and/or embodiments of the philanthropic management system are set forth in the attached figures and in the description hereinbelow as described in the claims hereinbelow. Accordingly, it should be understood that this Summary does not contain all of the aspects and embodiments of the novelty disclosed herein. Thus, this Summary is not meant to be limiting or restrictive in any manner. Further, the invention(s) as disclosed herein is/are to be understood by those of ordinary skill in the art to encompass obvious improvements and modifications thereto.

### BRIEF DESCRIPTION OF THE DRAWINGS

The Figures described below are a small portion of the website for an embodiment of the philanthropic management system of the present disclosure. Note that PCX in the figures is the name of philanthropic management system disclosed in the figures.

FIGS. A-1 through A-2 show a home page for an embodiment of the philanthropic management system of the present disclosure which gives an overview of the turn-key internet based planned giving system offered.

FIGS. B-1 and B-2 are a brief overview of for an embodiment of the philanthropic management system of the present disclosure introducing the services offered to clients.

FIG. C-1 is a page from a client's website introducing the concept of Stewardship and Estate Planning to the contributors of a client philanthropic organization for an embodiment of the philanthropic management system of the present disclosure, wherein such introduction is consistent with the beliefs and/or values of the client, and is used to educate contributors regarding such beliefs as they relate to contributing to the client philanthropic organization.

FIGS. D-1 through D-3 are pages from a client philanthropic organization's website giving an overview of Stewardship in Estate Planning concepts to educate contributors of the client, wherein such overview is consistent with the beliefs and/or values of the client, and is used to educate contributors regarding such beliefs as they relate to contributing to the client philanthropic organization.

FIGS. E-1 through E-3 are pages from a client philanthropic organization's website containing testimonials from end users of the services provided by the philanthropic management system.

FIGS. F-1 through F-2 are pages from a client's website detailing the concept of Stewardship, wherein such overview is consistent with the beliefs and/or values of the client, and is used to educate contributors regarding such beliefs as they relate to contributing to the client philanthropic organization.

FIGS. G-1 through G-6 are pages from a client's website setting forth case studies of several different contributors' situations and life issues and how proper estate planning solved potential estate problems.

FIGS. H-1 through H-7 are pages from a client's website setting forth an “estate planning primer” which explains the basic tools of estate planning and how they are used.

FIG. I-1 is a page from a client's website explaining how a contributor can get started in his or her estate planning process.

FIGS. J-1 through J-2 are pages from a website for the philanthropic management system describing some of the marketing material available to clients.

### DETAILED DESCRIPTION OF THE INVENTION

“Clients” referred to in this application are philanthropic organizations or entities (e.g., charities or non-profit organizations) seeking to raise funds from among its contributors (i.e., current donors and prospective new donors).

“Contributors” referred to in the present disclosure are individuals who have made or will make charitable contributions to a philanthropic organization or entity of their choice.

“Webinar” referred to in the present disclosure is a seminar conducted via a website for the philanthropic management system, which includes interactive features as well as pre-recorded material.

The invention claimed includes a web based system to educate, motivate and empower individual contributors to make charitable gifts to philanthropic organizations or entities having similar beliefs and/or values as described in the Summary section hereinabove.

In one embodiment of philanthropic management system, all information, presentations and advisor contacts are based on a Judeo-Christian beliefs and/or values as related to situations, circumstances and/or events that occur beyond the lifetimes of individuals identified with the philanthropic entity. However, other beliefs and/or values are also within the scope of the present disclosure. For example, an embodiment of the philanthropic management system may also assist philanthropic organizations or entities in obtaining contributions, wherein such an organization or entity may directed to environmental issues, and accordingly hold and espouse beliefs and/or values as related to situations, circumstances and/or events that relate, e.g., to reducing the effects of man made climate changes occurring both now and beyond the lifetimes of individuals identified with the philanthropic entity, and/or saving endangered species.

In one embodiment, the philanthropic management system has various Internet interfaces. A first such interface is for accessing a primary website that is accessible by the general population of Internet users, but is primarily intended for the clients of the management system, wherein clients (e.g., philanthropic entities or organizations) can access materials for marketing giving plans to contributors.

For each client philanthropic entity subscribing to the services offered by the philanthropic management system, an additional interface is available for the contributors to the philanthropic entity. Each such additional interface is tailored to identify the client, the client's unique logo, etc.

When a contributor and/or client subscribes to (or registers for) the services of the philanthropic management system, such subscribers have access to study courses, online seminars, up to date web based information, marketing materials, legal professionals and more.

Once a client subscribes to the services of the philanthropic management system, the website therefor can be tailored to that client, using their logos and slogans, and generally looking like a part of the client's website. The tailor made website is then linked into the client's website for seamless navigation by the client's contributors.

When a client's contributors are navigating the client's website, they can link to an embodiment of the philanthropic management system, including an Estate Plan Organizer, which they can fill out in private, send securely to philanthropic management system, who can then contact them with options for an successful estate plan. Other links from the client website may include an overview of estate planning issues, a client perspective of stewardship, gift opportunities, case studies, and general statistics and ideas from other “real life” contributors. Contributors are also given the opportunity to seek the assistance of an attorney from a preferred network of attorneys (at a reduced fee). This network of attorneys may utilize the services of a third party company. This network of attorneys providing local legal advice to contributors is an important aspect that heretofore prevented or inhibited clients from getting their contributors from the stage of intending to make a client contribution to fully executing a charitable gift plan.

What is claimed is:

1. A method of managing philanthropic belief based contributions for a plurality philanthropic entities, comprising:
for each philanthropic entity of the plurality of philanthropic entities, perform the following steps (a) through (g):
(a) storing information for providing to one or more users, wherein the information is related to contributing to the philanthropic entity, wherein the philanthropic entity's beliefs or values relating to situations, circumstances or events that occur beyond the lifetimes of the users are at least determined to be consistent with the information;
wherein the stored is in a form for transmitting to the users on the Internet from a first Internet site;
wherein an Internet link to the first Internet site provides access to the stored information, and the link is provided on an Internet presentation transmitted to the users from a different Internet site identified with the philanthropic entity;
(b) receiving user requests for the information during access to the first network site via the link;
(c) transmitting Internet responses to the user requests from the first Internet site, wherein responsive presentations to the users are identified with the philanthropic entity, and are obtained from the stored information;
(d) interactively communicating with the users from the first Internet site for providing data relating to a quantitative financial or economic projection of a contribution to the philanthropic entity, wherein the data is indicative of a net negative financial or economic impact to the user;
(e) providing the users with contacts for individuals knowledgeable in charitable giving to the philanthropic entity, wherein the individuals have been selected for their beliefs about situations, circumstances or events that occur beyond the lifetime of the individuals, and wherein the beliefs of the individuals are at least consistent with the philanthropic entity's beliefs or values relating to situations, circumstances and/or events that occur beyond the lifetimes of persons identified with the philanthropic entity;
(f) receiving, in Internet transmissions from each of the users, corresponding contribution related information for contributing to the philanthropic entity, wherein the contribution related information includes one or more of: information for preparing a will, information for preparing a revocable living trust, a bypass trust, a testamentary charitable remainder trust, and a children's trust; and
(g) for each of the users, providing an Internet transmission to one of the individuals selected by the user, the Internet transmission including at least a portion of the corresponding contribution related information for the user.

2. The method of claim 1 further including a step of restricting or filtering at least one contact from being provided to the users, wherein the at least one contact is for an individual that expressly states or otherwise advocates acts that are inconsistent with the philanthropic entity's beliefs or values relating to situations, circumstances and/or events that occur beyond the lifetimes of persons identified with the philanthropic entity.

3. The method of claim 1, wherein for a first and a second of the philanthropic entities, a first portion of the stored information is transmitted to users of each of the first and second philanthropic entities, and the step (c) of transmitting transmits: (i) a first of the responsive presentations to the users for the first philanthropic entity being the philanthropic entity, wherein the first responsive presentations do not identify the second philanthropic entity, and (ii) a second of the responsive presentations to the users for the second philanthropic entity being the philanthropic entity, wherein the second responsive presentations do not identify the first philanthropic entity.
